(19) United States
(12) Patent Application Publication
(10) Pub. No.: US 2020/0255299 A1
(43) Pub. Date: Aug. 13, 2020

(54) DEVICE AND METHODS FOR CONTINUOUS FLOW SEPARATION OF PARTICLES BY GAS DISSOLUTION

(71) Applicant: The Trustees of Princeton University, Princeton, NJ (US)

(72) Inventors: Howard A. STONE, Princeton, NJ (US); Orest Shardt, Princeton, NJ (US); Sangwoo Shin, Princeton, NJ (US); Patrick B. Warren, Wirral (GB)

(21) Appl. No.: 16/330,701

(22) PCT Filed: Sep. 1, 2017
(86) PCT No.: PCT/US2017/049819

§ 371 Date: Mar. 5, 2019

Related U.S. Application Data
(60) Provisional application No. 62/383,719, filed on Sep. 6, 2016.

(51) Int. Cl. C02F 1/00; B01D 61/58; C02F 1/48

(52) U.S. Cl. CPC C02F 1/001; C02F 2301/022; C02F 1/48; B01D 61/58

(57) ABSTRACT

Disclosed is a separation device and a method for separating charged particles from a liquid stream. The separation is effected by establishing an ion concentration gradient across the direction of the liquid stream by the introduction of a gas which when contacted with the liquid, in a reversible reaction, forms a soluble ionic species. A concentration gradient is maintained across the direction of the liquid stream which in turn induces separation of charged particles within the liquid stream due to the effect of diffusiophoresis. The device operates using little or no power, and dispenses with the need for filtration media or separation membranes. The device and method is adaptable to any of a number of separation processes, including biological separation processes, water purification and industrial processes.

The present invention claims priority to U.S. Ser. No. 62/383719, filed 6 Sep. 2016, the entire contents of which are herein incorporated by reference thereto.

Fluid transport that is driven by gradients of pressure, gravity, or electro-magnetic potential is well-known and studied in many fields. A subtler type of transport, called diffusiophoresis, occurs in a gradient of chemical concentration, either electrolyte or non-electrolyte. Diffusiophoresis has been defined as the migration of a particle in a solution or a suspension (i.e., colloidal suspension) in response to the macroscopic concentration gradient of a solute that interacts with the surface of the particle; depending upon the charge of particles the particle may move in a specified direction. Although the mechanism of diffusiophoresis is itself well-known, the diffusiophoresis mechanism is often considered to be an esoteric laboratory phenomenon, and has not been found to be particularly useful in larger scale separation processes which lend themselves to industrial applications.

The publication, “Boosting Migration of Large Particles by Solute Contrasts” by B. Abecassis, C. Cottin-Bizonne, C. Ybert, A. Ajdari and L. Bocquet, Nat. Mater., 7, (2008), pp. 785-789 describes particle diffusiophoresis, but does not disclose any other mechanisms for creating an ion gradient in a liquid by the use of a dissolved gas in the liquid to form such ion concentration gradients.

The present invention comprises several aspects, including those disclosed immediately hereinafter.

In one aspect the present invention is directed to a device effective in separating particles in a flowing suspension of the particles in a liquid which separation operates by dissolving gas into the liquid of the suspension to create an ion concentration gradient, and thereby imparting motion to the charged particles within the liquid and allowing for the creation of particle-rich and particle-depleted regions which may thereafter be separated. The device according to the preset aspect may be used by itself, or a plurality of individual devices may be operated in a parallel and/or serial fashion as described in more detail hereinafter.

In another aspect there is provided a method for separating charged particles in a flowing suspension which operates by dissolving gas into the suspension to form a concentration gradient of ions within the liquid, which concentration gradient causes the migration of the suspended particles due to diffusiophoresis to different regions within the flowing suspension which creates regions of high and low particle concentration, which are thereafter then separated from one another. The method may be practiced as a single separation process or multiple single separation processes may be practiced in parallel and/or serial fashion as described in more detail hereinafter.

The disclosed device and method may be used to supplement, complement, or as a replacement for existing filtration technologies.

The disclosed process offers at least several key advantages over conventional filtration techniques. First, the separated particles from the flowing suspension do not accumulate on a surface (i.e., a filter or filter substrate) over time, which causes a pressure drop across the surface, and consequently imposes that the filtration apparatus be taken offline in order to permit for the cleaning or replacement of the surface. Second, the device and method of the invention does not require the transport of the suspension through filter media, such as filters or membranes, causing clogging thereof and a consequent pressure drop across such filter media, which would reduce operating efficiency. Thirdly the separation of the particles is operable in a dynamic manner, that is to say does not rely upon the static storage of a quantity of the suspension to allow for flocculation to occur in order to cause separation of particles from a liquid carrier or liquid phase. Fourthly the devices of the invention require little or no maintenance, particularly as no filter media requires replacement. Other advantages will be understood from a further reading of this specification.

The disclosed device and method may be used to separate charged particles from within a carrier or bulk liquid within which the charged particles are entrained or are suspended, i.e. a colloid. The charged particles are responsive to an ion gradient present within the liquid within the disclosed device, such that wherein a region having an ion concentration gradient is present in the liquid, the particles will move in one direction within this gradient. While the disclosed device and method may be used in manner wherein the liquid is static and is not a flowing stream, in preferred embodiments the ion concentration gradient is present in the liquid and oriented in a direction which is angled with respect to or which is more preferably transverse to the direction of a flowing liquid comprising the charged particles, such that the movement of the charged particles occurs within this ion concentration gradient as a result of phoretic motion induced upon the particles, thus creating regions of high and low particle concentration within the liquid which may be subsequently separated from one another.

The disclosed device and method may be used to separate differently charged particles from within a carrier or bulk liquid within which the particles are entrained or are suspended, i.e. a colloid. For example particles having a positive charge may be separated from particles having a negative charge may be separated from each other using the disclosed device and method. The charged particles are responsive to an ion gradient present within the liquid within the disclosed device, such that wherein a region having an ion concentration gradient is present in the liquid, particles of various sizes and shapes, different charges (i.e., negative, or positive) and/or of differing magnitudes will move in different directions within this gradient. While the disclosed device and method may be used in manner wherein the liquid is static, in preferred embodiments the ion concentration gradient is present in the liquid is present in a direction which is angled with respect to or which is more preferably transverse to the direction of a flowing liquid comprising the charged particles, such that the movement of charged particles occurs within this ion concentration gradient as a result of phoretic motion induced upon the charged particles, creating regions of different particle concentrations which may be subsequently separated from one another.

The ion concentration gradient within the liquid is formed by first introducing a gas which is soluble in containing liquid which will generate ions within the liquid. By way of non-limiting example, wherein water is the carrier or bulk liquid one or more of the following gases may be advantageously used: H₂S, CO₂, HCN, HCl, HBr, HF, HI, Cl₂, N₂O₄, NO₂, SO₂, SO₃, and NH₃, most of which form aqueous acidic species in water. Ammonia forms a basic solution but still forms ions within the liquid. Also useful are volatile organic acids whose vapour pressures and solubilities in water are sufficiently high at operating conditions of the process. Non-limiting examples of volatile organic acids include methanoic (formic) acid, which at 1 atmosphere has a boiling point of 100° C., ethanoic (acetic) acid, which at one atmosphere has a boiling point of 118° C. Others not particularly listed here may also be used as well.

In a preferred embodiment, the gas is CO₂ which in water undergoes the following reversible reaction:

CO₂+H₂O<==>H⁺+HCO₃⁻

forming dissolved carbonic acid in water, and thus providing dissolved ions in the water. Other ionic species may be formed using one or more different gases, and a plurality of differing ionic species may be present in and useful in forming the ionic concentration gradient. Second, the gradient is established by exposing the charged particle containing liquid to a pressure gradient of the one or more gases spanning the liquid. Such may be effectuated by locating the liquid in a cavity having a volume (or plenum) which has at least a first portion or wall of a gas permeable material, and at least a second and separate second portion or wall of a gas permeable material which are both transmissive to the gas used and which effectively contains the charged particle containing liquid. The gas pressure present at the first portion or wall, is greater or lesser than the gas pressure at the second portion or wall such that the differential between these pressures ensures at the gas permeates a respective portion or wall and dissolves in the liquid, and in part forms a dissolved ionic species, the other portion or wall at a lower relative gas pressure ensures that the concentration of the gas does not reach a saturation level thereby ensuring that an ion concentration gradient is formed within the charged particle containing liquid between these portions or walls. In one embodiment the gas behind the first portion or wall and the second portion or wall are both at higher than atmospheric pressure, but at different relative pressures. In another embodiment the gas behind one of the portions or walls is at a pressure above atmospheric pressure while the other portion or wall is at atmospheric pressure and does not necessarily contain the gas, but may be open to the ambient atmosphere. In a further embodiment one of the portions or walls is exposed to a vacuum.

An ionic concentration gradient may be formed and existing between parts of a cavity (or plenum) between a first portion or wall of a gas permeable material and a second portion or wall of a gas permeable material.

The concentration of the dissolved ionic species present within the liquid can be controlled by establishing a desired pressure gradient of the soluble gas across the liquid, that is to say a desired pressure gradient is established to the first portion or wall and the second portion or wall. As the soluble gas may be used with or without other inert gases, i.e., in a mixture, the pressure of the soluble gas controls the concentration of the dissolved ion species present in the liquid as other inert gases, if present, may not necessarily pass into liquid or if present in the liquid may not form a dissolved ionic species within the liquid which would be useful in a separation process. The relative ratio of the gas pressure(s) behind the first portion or wall and the gas pressure behind second portion or wall is preferably 100:0, as the value of zero contemplates that the gas pressure behind the second portion or wall is actually a vacuum. Preferably however the relative ratio is in the range of between about 100:0.1; more preferably is between about: 100:1, 50:1; 40:1, 30:1, 25:1, 20:1, 15:1, 10:1, 9:1, 8:1, 7:1, 6:1, 5:1, 4:1, 3:1, 2:1 and 1.5:1. Optimal pressures of the device of the invention will of course vary by the nature of the liquid and the solubility of the gas within the liquid, and may be established by reference to known solubility parameters and/or via routine analytical methods by operating a device according to the invention as a desired flowrate of the liquid and with a desired gas, and varying the desired pressure gradient across the liquid in order to determine the resultant degree of solubility of the gas, and the ionic concentration gradient established within the liquid, which in turn will vary the degree of separation of the charged particles using the device.

The control of the temperature of the liquid containing the charged particles also influences the ionic concentration gradient as the liquid temperature directly influences the solubility of the dissolved ionic species. Thus, control of this temperature may be used in addition to the control via establishing a desired pressure gradient across the liquid as described herein. Optimal temperatures will of course vary by the nature of the liquid and the solubility of the gas within the liquid, and may be established by reference to known solubility parameters and/or via routine analytical methods by operating a device according to the invention as a desired flowrate of the liquid and with a desired gas, and varying the temperature in order to determine the resultant degree of solubility of the gas, and the ionic concentration gradient established within the liquid, which in turn will vary the degree of separation of the charged particles using the device.

The nature of the particles to be separated may vary widely and it is contemplated that they have a net positive or negative charge when present within the liquid when within the device of the invention, such that they may be moved by phoretic motion induced upon the particles by the presence of dissolved ionic species with the liquid, which ionic species is formed by a the in-situ reaction of gas entering the liquid and the liquid itself; preferably the dissolved ionic species is formed by a reversible in-situ reaction. Two or more different types of particles having different charges may be simultaneously separated from a liquid. Such may have different charges, i.e., positive, negative charges. The particles themselves may be biological or non-biological materials. Their size is non-limiting; it is only required that they be suspended or entrained within a liquid and be responsive to the phoretic motion induced by the dissolved ionic species in the liquid. In a certain embodiment, the charged particles are microbiological organisms such as bacterium and/or may be pathogens. In further embodiments, the particles are non-biological materials which have a net charge or a surface charge which may be either positive or negative.

Advantageously a first gas cavity is present behind the first portion or wall, and a second gas cavity is present behind the second portion or wall; in such embodiments the gas present in a respective cavity may migrate into the liquid in the cavity across the said first portion or wall and the second portion or wall. The first and the second gas cavities may be attached to a suitable source or pressurized gas, or may be open to the atmosphere, or may be attached to a suitable apparatus or source of vacuum. In one specific embodiment the second gas cavity is merely the exposed ambient atmosphere.

In a preferred embodiment the cavity is a channel having a non-circular cross-section or is a tube having a circular cross-section as described in more detail hereinafter and as depicted in one or more of the drawings.

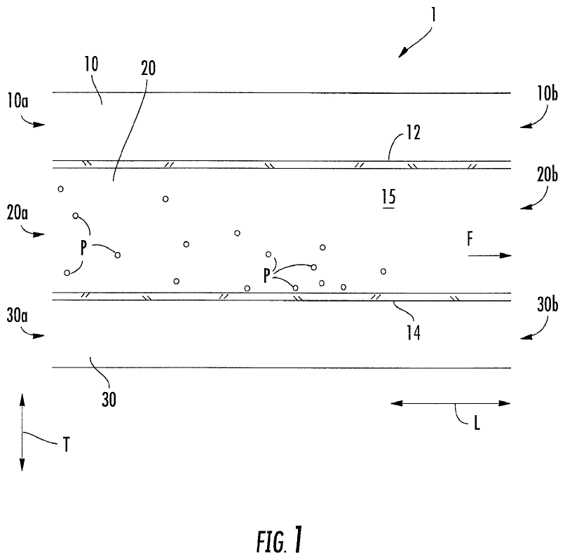

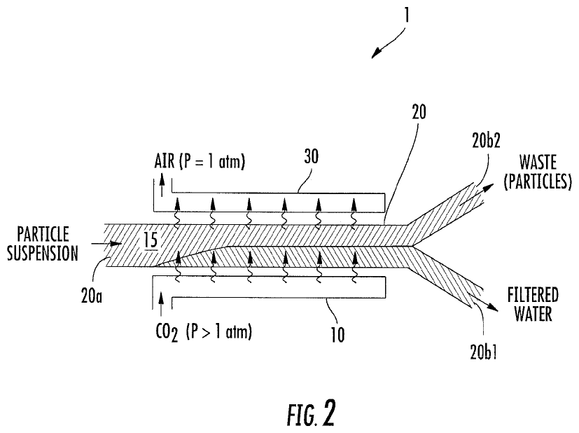

FIG. 1 illustrates a schematic depiction of a continuous flow particle separation device 1 having a first, pressurized (or pressurizable) cavity 10 or plenum adapted to contain a gas, separated by a first gas permeable wall 12 from a second cavity 20 or plenum which contains a charged particle (“p”) containing liquid 15 which also contains an ion species formed by the dissolution of the gas within the liquid, which is in turn separated by a second permeable wall 14 from the ambient atmosphere, or a third, relatively reduced pressure cavity 30 or plenum which may contain a gas or a vacuum; wherein the pressure present in the atmosphere or the third cavity 30 is lesser than that of the first cavity 10 thus forming an ion concentration differential within the liquid between first cavity and the atmosphere or the third cavity 30. The permeable walls 12, 14 operate to permit for the transfer of a gas from the first cavity 10 through the second cavity 20 and to the third cavity 30 or through the second permeable wall 14 to the atmosphere. In preferred embodiments at least the second cavity 20, but preferably each of the first, second and when present, the third cavities have a length dimension (schematically indicated by arrows “L”) and an average transverse dimension (schematically indicated by arrows “T”) which is measurable and which is generally or substantially perpendicular to the length dimension; preferably the length dimension is at least 10 times that of the average transverse dimension but is preferably even longer, e.g, at least 20, 30, 40, 50, 60, 70, 80, 90 or at least 100 times the average transverse dimension. Alternately the ratio of the length dimension: average transverse dimension, (sometimes is the average width or average diameter) of the second cavity is at least 10:1, preferably (and in order of increasing preference) is at least 25:1, 50:1, 100:1, 200:1, 300:1, 400:1, 500:1, and greater. Ensuring that the ratio of the length dimension is greater than the average transverse dimension, and preferably is a ratio of at least 10:1, but is preferably greater ensures that charged particle containing liquid 15 flowing (flow direction being indicated by arrow “F”) in the liquid containing cavity 20 has ample surface area of both the first and second permeable walls to ensure for gas transfer between the first and second cavities, and that the second permeable wall forming part of the third cavity maintains a negative pressure gradient between the first cavity and the third cavity. Further ensuring that the ratio of the length dimension is greater than the average transverse dimension, preferably is at least 25:1 or more, as such relatively high ratios facilitates the establishment of non-turbulent flow of the charged particle containing liquid 15 transiting through the liquid containing cavity 20. The device of the invention may however also operate under turbulent flow conditions of the liquid 15 transiting through the liquid containing cavity 20. However in particularly preferred embodiments the device operates such that the liquid within the liquid containing cavity 20 is within the laminar flow regime.

The ratio of the length dimension is greater than the average transverse dimension is desirably selected in view of the nature of the particles to be separated, the bulk liquid and the operating liquid flow conditions of the particle containing liquid within the liquid containing cavity 20. Ideally the length is sufficient so to allow for a desired degree of particle separation from within the bulk liquid, at the operating conditions of the device of the invention.

The materials of construction of the device may be virtually any material which may be used to maintain a satisfactory pressure differential between the first and second cavities, and the second and third cavities so to allow for the devices and methods of the invention operate as described herein. Such materials are desirably sufficiently rigid, and are chemically resistant, or chemically inert to any of the liquids and/or gas is being used in a separation process. Coming to consideration are any of a number of synthetic polymers, metals, ceramic materials, and the like. As to the construction of the cavities and/or intermediate walls which may be present, naturally these also additionally must exhibit the ability to allow for the diffusion or transfer of the gas used in the device and/or method between adjacent cavities. This will of course in no small part depend upon the operating characteristics of the device, and in particular the liquid, the nature of the particulates contained within the liquid, and that the gas to be used. Again, synthetic polymers, metals, ceramic materials, and in particular microporous materials which allow for the selective transfer diffusion of gas, but yet which retain liquid such as membranes of various types contemplated to be particularly useful. Non-limiting examples of such materials include: synthetic polymers such as silicone polymers, i.e., poly(dimethyl siloxane), poly(methyl propyl siloxane), poly(methyl octyl siloxane), poly(trifluoropropyl methyl siloxane), and poly(phenyl methyl siloxane); polyacetylenes and substituted polyacetylenes, i.e., poly(1-trimethylsilyl-1-propyne) (PTMSP), poly(4-methyl-2-pentyne) (PMP); polyolefins, i.e., polypropylene, poly(4-methyl-1-pentene); poly(2,6-dimethyl-1,4-phenylene oxide) (PPO); polyamides, aromatic polyamides (polyaramids); polyimides, fluorinated polyimides, i.e, 6FDA-DAF, 6FDA-TMDA (2,3,5,6-tetramethyl-1,4-phenylenediamine); polysulfones; polycarbonates; as well as those based on celluloses, i.e., ethyl cellulose, cellulose acetate, and cellulose triacetate. Other materials include hydrogels; microporous polymers, e.g. microporous PTFE; coated carbon paper/woven fabric as commonly used as a gas diffusion layer in fuel cells; natural polymers and ceramics.

A material which is advantageously used are polysiloxane-based polymers such as polydimethylsiloxane same having a sufficiently high molecular weight such that it provides both effective barrier characteristics to the liquid but at same time allow for the perfusion of the gas, i.e., carbon dioxide. Thickness of these materials, and a particular the thickness of the cavities and/or intermediate walls to allow both effective barrier characteristics of liquids, and yet a sufficiently high rate of gas transfer across such materials may be established empirically, or by routine experimentation and will of course vary upon the configuration of a particular device to be fabricated, according to the present inventive teaching.

The configuration of the parts of a device are preferably arranged in such a manner that at least part of the first, second and third cavities are parallel with respect to one another with a region or part of the first and second cavities separated by a first permeable wall, and with a region or part of the first and second cavities separated by a second permeable wall. Nonlimiting parallel configurations are disclosed with respect to one or more of the drawings.

In one particularly preferred embodiment the first 10, second 20 and third cavities 30 are preferably tubes or channel shaped cavities each having an inlet and at least one outlet, respectively: a first cavity inlet 10a and a first cavity outlet 10b; a second cavity inlet 20a and a second cavity outlet 20b; and, a third cavity inlet 30a and a third cavity outlet 30b. The first, second and third cavities may be substantially straight, but may also be curved or contain both substantially straight sections and curved sections as well. The first and third cavities necessarily include an inlet and/or an outlet, but both are not usually essential, as, for example the first cavity may contain an inlet through which a quantity of a pressurized gas may be supplied, but no outlet would be required as the gas would be permeable through the permeable wall thereof and into the second cavity. Not dissimilarly the third cavity may contain an outlet, through which gas entering the third cavity via the second permeable wall may enter from the second cavity may be withdrawn such as by a vacuum, or may be allowed to vent to the ambient atmosphere. It is also foreseen that the third cavity may be connected to a vacuum source so to ensure that the pressure in the third cavity is reduced compared to the pressure extant in the first cavity. It is also foreseen that the third cavity 30 may be absent, as the permeable wall 14 may be in direct contact with the ambient atmosphere (and exposed to 1 atm pressure.)

As the pressures within the first cavity 10 and the third cavity 30 differ, the concentration of the ionic species formed by the dissolved gas present in the liquid 15 varies transversely between the walls 12, 14. The concentration of the ionic species may also be in part controlled or influenced by the temperature of the liquid 15. Such induces the migration of the suspended particles P due to diffusiophoresis to different regions within the flowing suspension which creates regions of high and low particle concentration, which thereafter may be separated from one another. Such is schematically shown in FIG. 1; as is seen therein the local concentration of particles P adjacent to wall 14 is greater (within the same transverse location within the second cavity 20) than at wall 16. Thereby, the relative concentration of particles P within the liquid 15 differs in the flow direction F of the liquid and varies across the length of the second cavity 20. In such a manner, the liquid 15 may be divided downstream at one or more outlets 20b into separate streams, one having a higher relative concentration of the particles P than originally present at the inlet 20a (or “retentate”), the other having a lower relative concentration of the particles P than originally present at the inlet 20a (or “filtrate”). Such separation occurs without the need of a traditional filter medium, or membrane in order to achieve such separation. Such a separation occurs also without requiring any significant expenditure of energy as flow may be provided by gravity or with an energy efficient pumping means (i.e., mechanical pump).

The outlet of the second cavity 20 may include two or more outlets, with at least one (first) outlet containing and used to transport a quantity of the liquid containing a relatively reduced amount of the particulate, and at least one (second, or further) outlet containing a quantity of the liquid enriched in the particulate, both being relative to, or as compared to the liquid provided to the inlet 20a. In such a manner, the discrete concentration of the particles P within the different lamina of a liquid flowing through the second cavity 20 between its inlet and the outlet(s) may be controlled, and used as a separation process which does not require the use of a traditional filter medium through which the liquid must be allowed to, or forced to pass. Rather in the device and method of the present invention, the gas introduced in the first cavity migrates across the first permeable wall and into the particulate containing liquid flowing through the second cavity (or also referred to as the ‘liquid cavity’) wherein it becomes entrained, but preferably dissolved therein. The pressure differential across the second cavity, due to the relatively reduced pressure present in the third cavity induces gas transfer between the first and third cavity in a “net transverse direction”. A difference in the partial pressures of the soluble gas is required; whereas the total pressure may be constant. The direction of the gas flow transverse to the longitudinal flow direction of the particulate containing liquid ensures that a concentration gradient of the dissolved gas is present within the second cavity between the first and the third cavities, which in turn facilitates segregation of charged particles within the liquid.

The process and apparatus of the invention may also be used to concurrently separate two (or more) different types of species of charged particles as well.

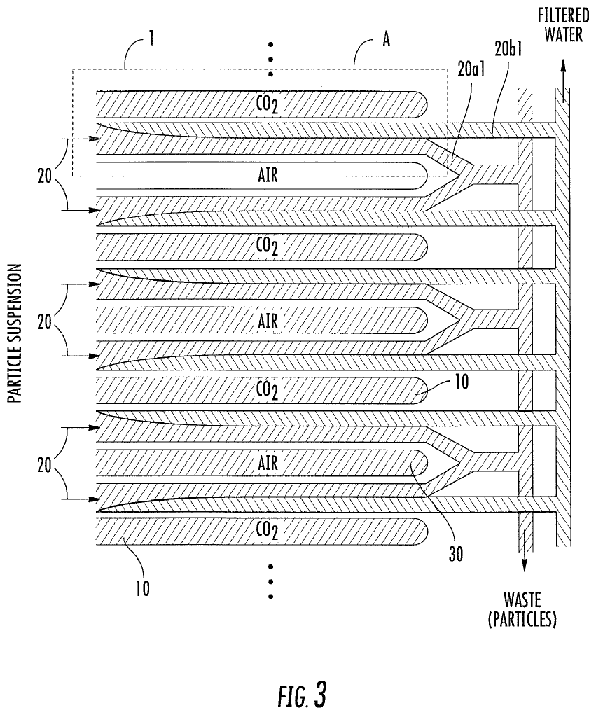

With reference now to FIG. 2, therein is depicted schematic of a continuous flow membrane-less filtration device 1 according to the invention, which here is depicted as being used as a water filtration device and utilizes CO₂ as a gas for forming the dissolved ionic species within water being pumped through the liquid cavity of the device. The formation of the dissolved ionic species separates differently charged biological and non-biological materials entrained within the liquid, into two output liquid streams a first outlet stream 20b1 (“filtered water”) and a second outlet stream 20b2 (labeled “waste (particles):).

Devices of the invention may be used singly (or a “unit device”, which may be identified hereinafter in a dotted line box labeled “A”), or a plurality of such devices may be operated concurrently. Two or more such devices may be operated in serial fashion, in a parallel fashion or in a combination of both.

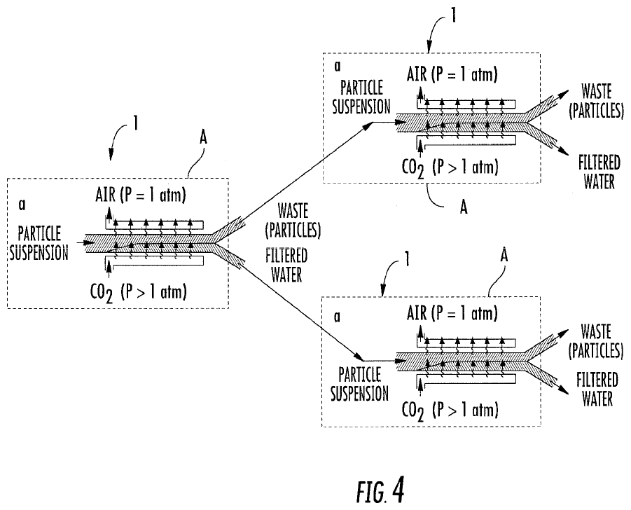

FIG. 3 depicts an array of individual devices 1 (one of which is labeled “A”) of the invention which are simultaneously operable in a parallel manner, wherein a liquid containing charged particles, e.g., a suspension or colloid, is separated via corresponding outlets 20a1 and 20b1 into a filtered water stream and a waste stream. As can be understood from consideration of the drawing, each inlet 20 of each device 1 is connected to a common source of the liquid containing charged particles (“particle suspension”), which are fed into the individual devices arrayed in parallel. It is to be noted that such a placement allows for two important features: (a) the placement of the first chamber containing, in this embodiment CO₂ alternates with that of the third chamber containing air, or more accurately are chambers open to the atmosphere in the ambient environment, such allows for the product of a physically more compact array of unit devices. As is also seen in FIG. 3, each of the unit devices has a plurality of outlets connected respectively to common outlet manifolds, one for receiving a filtrate (“Filtered water”) or a retentate (“Waste (particles)”).

While not shown in either of FIG. 1, 2 or 3, it is to be understood that any of the outlets of unit devices, whether used singly or in a plurality of such devices, may be connected to the inlets of one or more further unit devices A of the invention. Such is schematically depicted in FIG. 4. In such a manner serial filtration processes can be practiced, thereby providing further degrees of improved separation of charged particles originally present in the liquid. As such may also advantageously increase the overall operating efficacy of separation of charged particles, and, as the unit devices do not require filtration medium and require little power in order to ensure the operation; in some embodiments the use of a plurality of unit devices is preferred. It is also to be understood that in such a configuration as depicted in FIG. 4, that an intermediate step occurs, in which any dissolved gas at an outlet of a stage is removed or vented out, prior to the entry of the liquid into a next stage.

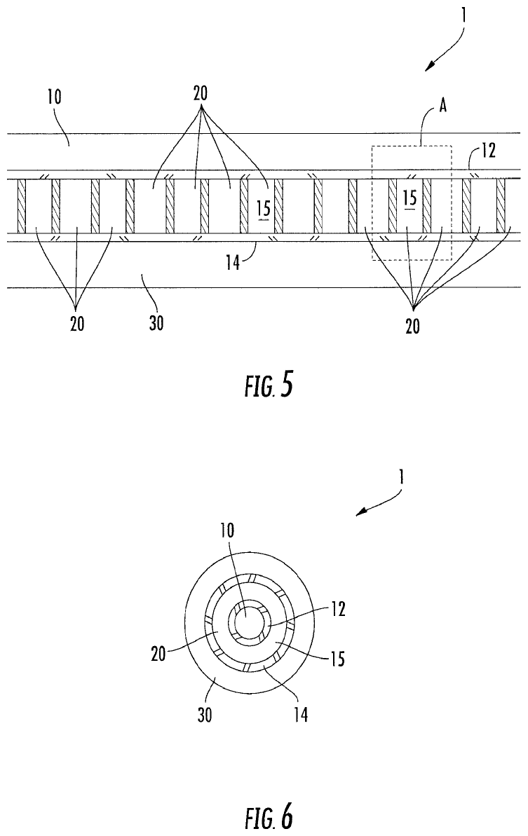

FIGS. 5 and 6 illustrate cross-sectional views of devices according to the invention having different configurations.

In FIG. 5 is depicted a series of parallel channels each which define a second cavity 20 (or container, or plenum) each adapted to contain the charged particle containing liquid 15 bounded on one side by a first gas permeable wall 12 forming a barrier with a first, pressurized (or pressurizable) cavity 10 adapted to contain a gas, and bounded on another side by a second gas permeable wall 14, forming a barrier with a third, relatively reduced pressure cavity 30 which may contain a gas or a vacuum or which may be open to the ambient atmosphere. The depicted embodiment may be formed into an ordered array of such elements in a manner generally disclosed in FIG. 3 with each of the individual parallel channels 20 operating in conjunction with adjacent regions of the first gas permeable wall 12 and second gas permeable wall 14 and corresponding cavities 10, 30 as individual unit devices A; such that the plurality of channels 20 function as a compact array of unit devices operating in parallel.

FIG. 6 depicts a schematic cross-section of a different embodiment of a device of the invention than previously shown. In this embodiment, the first cavity 10 is within the second cavity 20, and both the first and second cavities are within the third cavity 30. In the depicted embodiment the first gas permeable wall 12 and the second gas permeable wall 14 are each tubular in configuration, and are substantially concentric. The third cavity 30may be of any configuration, or as previously noted can be omitted as leaving the second gas permeable wall 14 open to the atmosphere if such is desired.

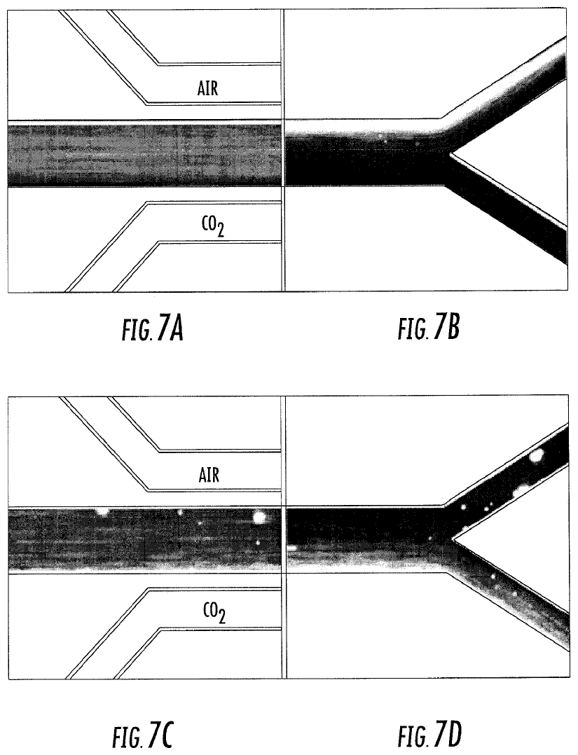

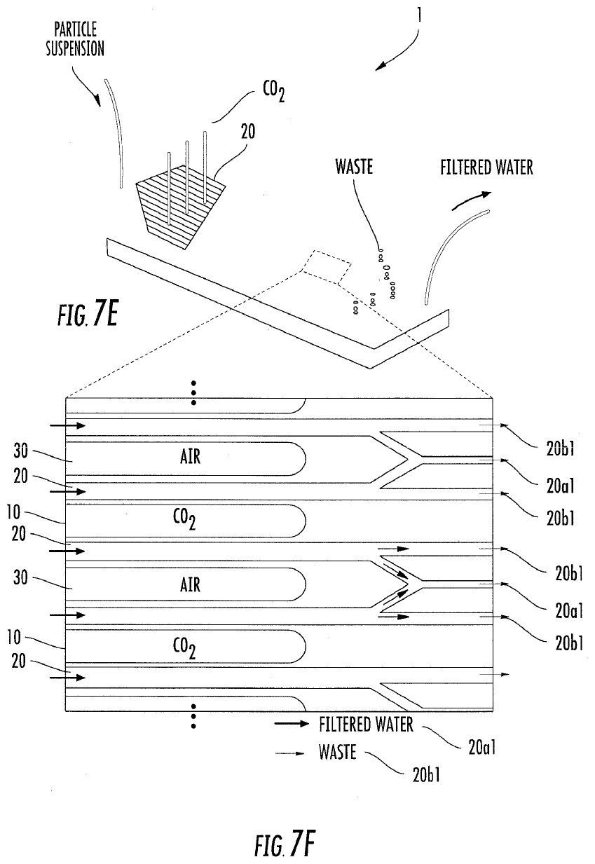

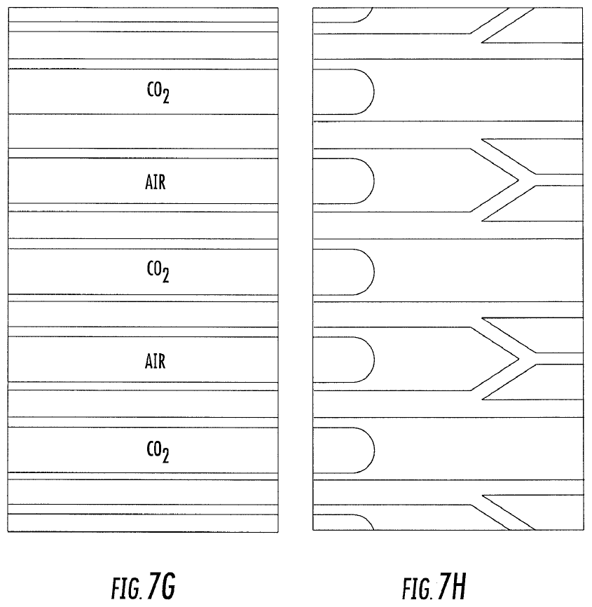

FIG. 7e depicts an embodiment of a device of the invention having a series of 10 parallel and longitudinal second channels 20 (or “flow channels”) for containing flowing liquid containing charged particles, and parallel first cavities 10 for containing pressurized CO₂ gas, and further third cavities 30 open to the ambient atmosphere, and at a reduced pressure relative to the CO₂ gas. The device operates in a manner as disclosed in FIG. 3.

The device 1 was constructed from a polydimethylsiloxane material (“Sylgard 184 Elastomer”) kit, ex. Dow Corning) using a conventional soft lithography technique. The monomer and cross-linker provided in the kit were mixed that it was ratio of 10:1. The second channels 20 has a width of 0.1 mm, a height of 0.02 mm and a length of 30 mm. The thickness of the polydimethylsiloxane material used to provide the gas permeable walls 12, 14 was 30 microns.

When operating the second channels had a flow rate of 2 μl/h; and the pressure drop across the channel was Δp≈0.2 kPa. The device was used to separate negatively charged particles present in a stream of deionized water, pumped through the apparatus using a syringe pump (“PhD Ultra”, ex Harvard Apparatus.)

The foregoing device was also used in the same manner to evaluate separation of positively charged particles as well. However, in order to avoid undesired adhesion of the positively charged particles to the walls of the second channels 20, first they were contacted by a 1% aqueous solution of 3-aminopropyltrimethoxysilane (ex. Sigma-Aldrich) was pumped through the second channels for 20 minutes, followed by rinsing with deionized water for 10 minutes. Thereafter, a liquid containing positively charged particles was provided to the device.

FIG. 7f is an “enlarged view” of part of the device illustrating a detail of the first 10, second 20 and third cavities 30, and how in operation charged particles are separated into separate outlets 20a1, 20b1. As is seen then, the filtrate stream, (“filtered water”), is separated from a retentate stream (“Waste”) which has a different concentration of charged particles than the filtrate stream.

This behavior is illustrated in the following FIGS. 7a, 7b, 7c and 7d which are fluorescence microscopy images of negatively charged particles (FIG. 7a, 7b) and positively charged particles (FIG. 7c, 7d) migrating transverse the flow direction within a second cavity of a unit device. The pressure of the CO₂ gas in the first cavity 10 was maintained at 10 psig. The thickness of the intermediate walls between the first 10, second 10 and third cavities 30 was 30 microns. Water was the bulk liquid, at room temperature (24° C.). FIGS. 7a, 7b illustrate the behavior of negatively charged polystyrene particles having a diameter of 0.5 microns, which as first illustrated in FIG. 7a are generally uniformly distributed in the liquid, but as seen in FIG. 7b, these particles are shown as migrating away from the wall that is adjacent to the CO₂ containing cavity as they flow downstream. FIGS. 7c, 7d illustrate the behavior of positively charged amine-functionalized polystyrene particles having a diameter of 1 micron, which as first illustrated in FIG. 7c are generally uniformly distributed in the liquid, but as seen in FIG. 7b, these particles are shown as migrating away from the wall that is opposite wall, and away from the wall bounding the CO₂ containing cavity and towards the wall in contact with ambient air as they flow downstream, as a result of diffusiophoresis.

FIGS. 7g, 7h are fluorescence microscopy images of negatively charged particles near the inlet of the cavities 20 containing the liquid and the charged particles (FIG. 7g) in the region of the outlets of the cavities; here the device was operated such that the CO₂ pressure was 5 psig. As is seen from the different densities of the particles shown in FIG. 7h, effective separation of particles is achieved, as a result of diffusiophoresis.

The device and method of the invention may be used in any application which would benefit from such a separation technology, which as disclosed does not require the use of convention filtration media such as porous filters, such as fibrous, metal or ceramic filters or membrances, nor require establishing an electrical field such as may be required in electrolytic separation processes.

1. A device operative in separating particles in a flowing suspension of the particles in a liquid which device comprises:
a first, pressurized cavity or plenum adapted to contain a gas, separated by a first gas permeable wall from a second cavity or plenum which contains a charged particle containing liquid which also contains an ion species formed by the dissolution of the gas within the liquid, which is in turn separated by a second permeable wall from the ambient atmosphere or an optional, third, relatively reduced pressure cavity or plenum which may contain a gas or a vacuum; wherein:
the permeable walls operate to permit for the transfer of a gas from the first cavity through the second cavity and through the second permeable wall to the atmosphere or a third cavity and,
the pressure present in atmosphere or the third cavity is lesser than that of the first cavity, thus forming an ion concentration differential within the liquid and between the permeable walls.

2. The device of claim 1, wherein the second cavity [[20]] has a length which is at least 10 times its average transverse dimension.

3. The device of claim 2, wherein the second cavity has a lengthy which is at least 50 times its average transverse dimension.

4. The device of claim 1, wherein the first cavity has a length which is at least 10 times its average transverse dimension.

5. The device of claim 4, wherein the second cavity has a length which is at least 50 times its average transverse dimension.

6. The device of claim 1, wherein the third cavity has a length which is at least 10 times its average transverse dimension.

7. The device of claim 6, wherein the third cavity has a length which is at least 50 times its average transverse dimension.

8. The device of claim 1, wherein no third cavity is present.

9. A plurality of devices of claim 1 connected in a serial manner, or in a parallel manner.

10. A continuous method for the separation of charged particles from a stream of a liquid which includes the steps of:
supplying the liquid containing the charged particles to the second cavity of the device of claim 1,
supplying a pressurized gas to the first cavity,
operating the device to establish a pressure gradient of the gas within the liquid, thereby causing the formation of ionizable species within the liquid and an ionic concentration gradient within the liquid causing the migration of the suspended particles due to diffusiophoresis to different regions within the flowing suspension which creates regions of high and low particle concentration, and,
separating the different regions.

11. The method of claim 10, wherein the different regions are a filtrate and a retentate.

12. The method of claim 10, wherein the gas is soluble in the liquid.

13. The method of claim 12, wherein the gas forms an aqueous acidic species in water.

14. The method of claim 12, wherein the gas is one or more of: H₂S, CO₂, HCN, HCl, HBr, HF, HI, CL₂, N₂O₄, NO₂, SO₂, SO₃, and NH₃.

15. The method of claim 14, wherein the gas is CO₂.

16. The method of claim 10, wherein the devices separates two or more different types of particles having different charges from the liquid.

17. The method of claim 10, wherein the liquid is water.

18. The method of claim 17, wherein the liquid is water and the charged particles are microbiological organisms,
